(19) United States
(12) Patent Application Publication
(10) Pub. No.: US 2024/0080919 A1
(43) Pub. Date: Mar. 7, 2024

(54) METHOD AND APPARATUS FOR MULTI-PATH COMMUNICATION WITH NETWORK IN A WIRELESS COMMUNICATION SYSTEM

(71) Applicant: ASUS Technology Licensing Inc., Taipei City (TW)

(72) Inventor: Richard Lee-Chee Kuo, Taipei City (TW)

(21) Appl. No.: 18/227,789

(22) Filed: Jul. 28, 2023

Related U.S. Application Data
(60) Provisional application No. 63/404,137, filed on Sep. 6, 2022.

(51) Int. Cl. H04W 76/11; H04W 76/27

(52) U.S. Cl. CPC H04W 76/11; H04W 76/27; H04W 88/04

(57) ABSTRACT

A method and device for supporting multi-path transmission or communication. In one embodiment, a User Equipment (UE) establishes a Radio Resource Control (RRC) connection with a network node. The UE also transmits a RRC message to the network node, wherein the RRC message includes a Cell Radio Network Temporary Identifier (C-RNTI) of a relay UE. Furthermore, the UE receives a RRC Reconfiguration message from the network node, wherein the RRC Reconfiguration message includes a configuration of a Data Radio Bearer (DRB) and wherein the DRB is mapped to a first Radio Link Control (RLC) entity in the UE and a second RLC entity in the relay UE. In addition, the UE transmits a data packet of the DRB to the network node via the first RLC entity and/or the second RLC entity.

### CROSS-REFERENCE TO RELATED APPLICATIONS

The present application claims the benefit of U.S. Provisional Patent Application Ser. No. 63/404,137 filed on Sep. 6, 2022, the entire disclosure of which is incorporated herein in its entirety by reference.

### FIELD

This disclosure generally relates to wireless communication networks, and more particularly, to a method and apparatus for multi-path communication with network in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for supporting multi-path transmission or communication. In one embodiment, a User Equipment (UE) establishes a Radio Resource Control (RRC) connection with a network node. The UE also transmits a RRC message to the network node, wherein the RRC message includes a Cell Radio Network Temporary Identifier (C-RNTI) of a relay UE. Furthermore, the UE receives a RRC Reconfiguration message from the network node, wherein the RRC Reconfiguration message includes a configuration of a Data Radio Bearer (DRB) and wherein the DRB is mapped to a first Radio Link Control (RLC) entity in the UE and a second RLC entity in the relay UE. In addition, the UE transmits a data packet of the DRB to the network node via the first RLC entity and/or the second RLC entity.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.3.3.1-1 of 3GPP TS 38.331 V17.1.0.

FIG. 6 is a reproduction of FIG. 5.3.3.1-2 of 3GPP TS 38.331 V17.1.0.

FIG. 7 is a reproduction of FIG. 5.3.5.1-1 of 3GPP TS 38.331 V17.1.0.

FIG. 8 is a reproduction of FIG. 5.3.5.1-2 of 3GPP TS 38.331 V17.1.0.

FIG. 9 shows a User Plane (UP) protocol stack for multi-path communication with relay UE in according to one exemplary embodiment.

FIG. 10 illustrates examples of the above solutions to add an indirect path for supporting multi-path communication according to one exemplary embodiment.

FIG. 11 is a flow chart according to one exemplary embodiment.

FIG. 12 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: RP-213585, “New WID on NR sidelink relay enhancements”, LG Electronics; R2-2208429, “Multi-path and UE aggregation”, CMCC; TS 38.331 V17.1.0, “NR; Radio Resource Control (RRC) protocol specification (Release 17)”; TS 38.321 v17.1.0, “NR; Medium Access Control (MAC) protocol specification (Release 17)”; and TS 38.323 v17.1.0, “NR; Packet Data Convergence Protocol (PDCP) specification (Release 17)”. The standards and documents listed above are hereby expressly incorporated by reference in their entirety.

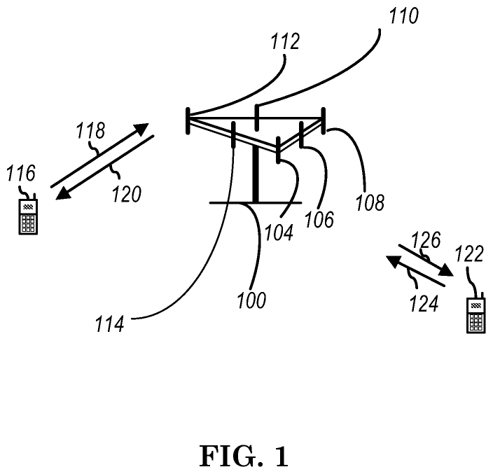

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

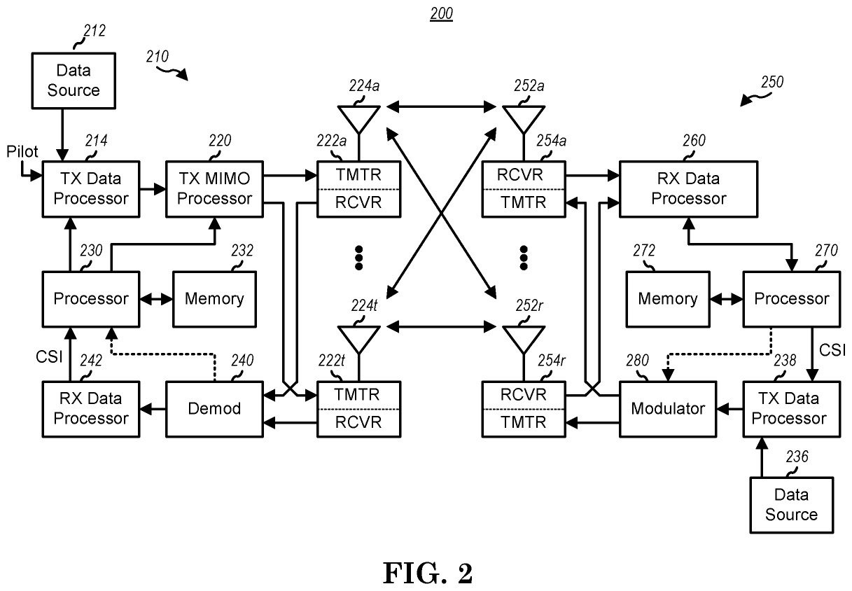

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

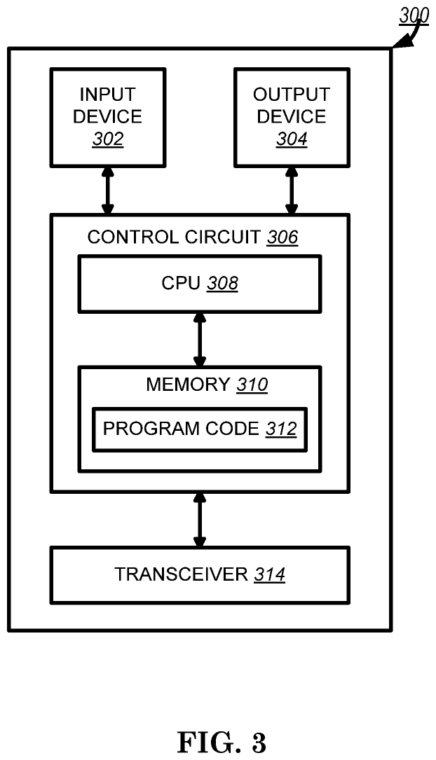

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

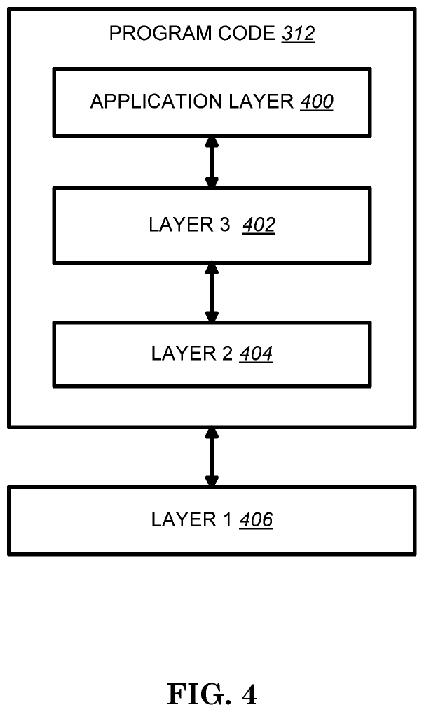

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP RP-213585 is a new Work Item Description (WID) on N_{R} sidelink relay enhancements for Release 18. The justification and objective in this WID are as follows:

### 4 Justification

[ . . . ]
In addition, support of multi-path with relay, where a remote UE is connected to network via direct and indirect paths, has a potential to improve the reliability/robustness as well as throughput, so it needs to be considered as an enhancement area in Rel-18. This multi-path relay solution can also be utilized to for UE aggregation where a UE is connected to the network via direct path and via another UE using a non-3GPP standardized UE-UE interconnection. UE aggregation aims to provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well, that is, if the channel condition of a terminal is deteriorating, another terminal can be used to make up for the traffic performance unsteadiness caused by channel condition variation.

### 4 Objective

4.1 Objective of SI or Core part WI or Testing part WI
The objective of this work item is to specify solutions that are needed to enhance N_{R} Sidelink Relay for the V2X, public safety and commercial use cases.
[ . . . ]
1. Study the benefit and potential solutions for multi-path support to enhance reliability and throughput (e.g., by switching among or utilizing the multiple paths simultaneously) in the following scenarios [RAN2, RAN3]:
   A. A UE is connected to the same gNB using one direct path and one indirect path via 1) Layer-2 UE-to-Network relay, or 2) via another UE (where the UE-UE inter-connection is assumed to be ideal), where the solutions for 1) are to be reused for 2) without precluding the possibility of excluding a part of the solutions which is unnecessary for the operation for 2).
   Note 3A: Study on the benefit and potential solutions are to be completed in RAN #98 which will decide whether/how to start the normative work.
   Note 3B: UE-to-Network relay in scenario 1 reuses the Rel-17 solution as the baseline.
   Note 3C: Support of Layer-3 UE-to-Network relay in multi-path scenario is assumed to have no RAN impact and the work and solutions are subject to SA2 to progress.
      [ . . . ]

3GPP R2-2208429 elaborates on multi-path and UE aggregation. It describes authorization and association for UE aggregation as follows:

### Authorization and Association

For multi-path, authorization procedure for relay UE and remote UE is similar as R17 behaviour. However, for UE aggregation, in some cases, as the UE wherein is non handheld UE, e.g. equipped in the assembling line of factory or UAV for live video or 3D map transmission, the relationship between anchor UE and aggregated UE is relative static and can be pre-configured. Meanwhile, it is possible that the UE reports the association with other UEs to network subsequently the CN is response for the authorization to check whether the aggregated UE is trustful; Alternatively, the network (RAN or CN) may configure the association amongst UEs. To be specific, if anchor UE connects to more than one aggregated UE, association should be established, which is different from sidelink relay relying on L2 identity and PC5 discovery. For the pre-configure or association issue of aggregated UE should be further check in SA2, LS for that may be needed, which is depend on RAN2 progress in SI.
Proposal 3: RAN2 should discuss the work plan for authorization and association in case of authorization and association considering the time budget:
Phase 1: Just considering the relationship between anchor UE and aggregated UE is relative static and can be pre-configured (for the UEs wherein is non handheld UE, e.g. equipped in the assembling line of factory or UAV for live video or 3D map transmission);
Phase 2: Study some other cases, that is, the UE reports the association with other UEs to network, or the network (RAN or CN) may configure the association amongst UEs, where the SA2/CT1 work is possible to be involved, as CN is response for the authorization to check whether the aggregated UE is trustful.

3GPP TS 38.331 specifies a Radio Resource Control (RRC) connection establishment procedure for establishing a RRC connection between a UE and a gNB, and a RRC reconfiguration procedure for providing Uu radio resource configuration as follows:

### 5.3.3 RRC Connection Establishment

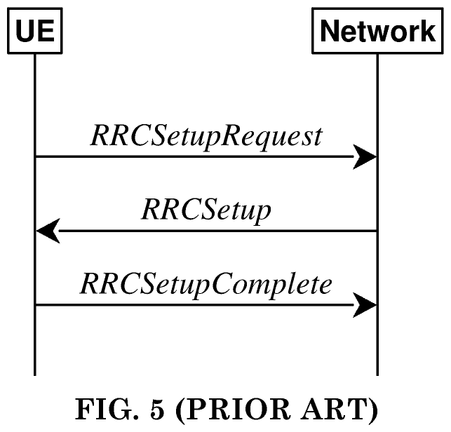

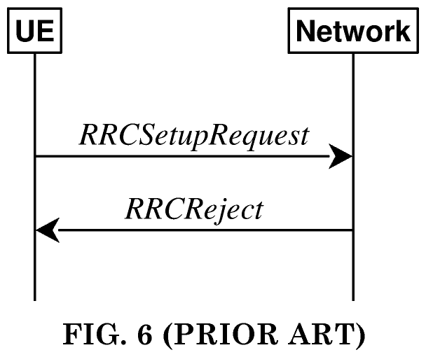

### 5.3.3.1 General

[FIG. 5.3.3.1-1 of 3GPP TS 38.331 V17.1.0, entitled “RRC connection establishment, successful”, is reproduced as FIG. 5]
[FIG. 5.3.3.1-2 of 3GPP TS 38.331 V17.1.0, entitled “RRC connection establishment, network reject”, is reproduced as FIG. 6]
   The purpose of this procedure is to establish an RRC connection. RRC connection establishment involves SRB1 establishment. The procedure is also used to transfer the initial NAS dedicated information/message from the UE to the network.
   The network applies the procedure e.g. as follows:
When establishing an RRC connection;
When UE is resuming or re-establishing an RRC connection, and the network is not able to retrieve or verify the UE context. In this case, UE receives RRCSetup and responds with RRCSetupComplete.
   [ . . . ]

### 5.3.5 RRC Reconfiguration

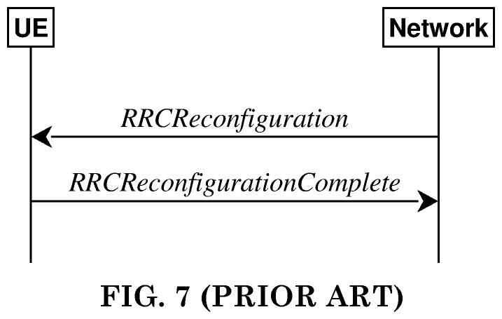

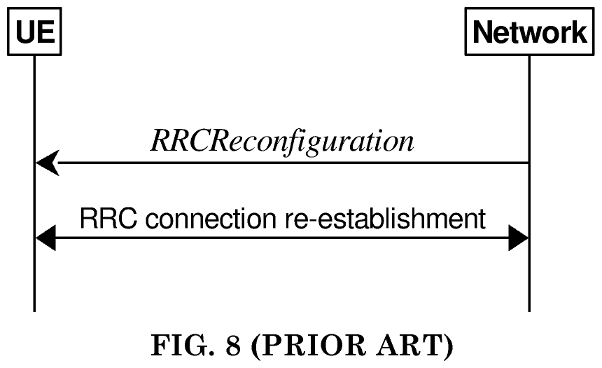

### 5.3.5.1 General

[FIG. 5.3.5.1-1 of 3GPP TS 38.331 V17.1.0, entitled “RRC reconfiguration, successful”, is reproduced as FIG. 7]
[FIG. 5.3.5.1-2 of 3GPP TS 38.331 V17.1.0, entitled “RRC reconfiguration, failure”, is reproduced as FIG. 8]
   The purpose of this procedure is to modify an RRC connection, e.g. to establish/modify/release RBs/BH RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration. As part of the procedure, NAS dedicated information may be transferred from the Network to the UE.
   RRC reconfiguration to perform reconfiguration with sync includes, but is not limited to, the following cases:
reconfiguration with sync and security key refresh, involving RA to the PCell/PSCell, MAC reset, refresh of security and re-establishment of RLC and PDCP triggered by explicit L2 indicators;
reconfiguration with sync but without security key refresh, involving RA to the PCell/PSCell, MAC reset and RLC re-establishment and PDCP data recovery (for AM DRB or AM MRB) triggered by explicit L2 indicators.
reconfiguration with sync for DAPS and security key refresh, involving RA to the target PCell, establishment of target MAC, and
   for non-DAPS bearer: refresh of security and re-establishment of RLC and PDCP triggered by explicit L2 indicators;
   for DAPS bearer: establishment of RLC for the target PCell, refresh of security and reconfiguration of PDCP to add the ciphering function, the integrity protection function and ROHC function of the target PCell;
   for SRB: refresh of security and establishment of RLC and PDCP for the target PCell;
reconfiguration with sync for DAPS but without security key refresh, involving RA to the target PCell, establishment of target MAC, and
   for non-DAPS bearer: RLC re-establishment and PDCP data recovery (for AM DRB or AM MRB) triggered by explicit L2 indicators.
   for DAPS bearer: establishment of RLC for target PCell, reconfiguration of PDCP to add the ciphering function, the integrity protection function and ROHC function of the target PCell;
   for SRB: establishment of RLC and PDCP for the target PCell.
      In (NG)EN-DC and NR-DC, SRB3 can be used for measurement configuration and reporting, for UE assistance (re-)configuration and reporting for power savings, for IP address (re-) configuration and reporting for IAB-nodes, to (re-)configure MAC, RLC, BAP, physical layer and RLF timers and constants of the SCG configuration, and to reconfigure PDCP for DRBs associated with the S-K_{gNB} or SRB3, and to reconfigure SDAP for DRBs associated with S-K_{gNB} in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.
      [ . . . ]

### 6.2.2 Message Definitions

[ . . . ]

RRCSetupRequest

The RRCSetupRequest message is used to request the establishment of an RRC connection.
[ . . . ]

-- ASN1START
-- TAG-RRCSETUPREQUEST-START

| | |
|---|---|
| RRCSetupRequest ::= | SEQUENCE { |
| rrcSetupRequest | RRCSetupRequest-IEs |

}

| | |
|---|---|
| RRCSetupRequest-IEs ::= | SEQUENCE { |
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, mo-Signalling, |
| | mo-Data, mo-VoiceCall, mo-VideoCall, mo-SMS, mps- |

PriorityAccess, mcs-PriorityAccess,

spare6, spare5, spare4, spare3, spare2, spare1}

-- TAG-RRCSETUPREQUEST-STOP
-- ASN1STOP

RRCSetupRequest-IEs field descriptions

establishmentCause
Provides the establishment cause for the RRCSetupRequest in
accordance with the information received from upper layers. gNB
is not expected to reject an RRCSetupRequest due to unknown
cause value being used by the UE.
ue-Identity
UE identity included to facilitate contention resolution by lower layers.

InitialUE-Identity field descriptions

ng-5G-S-TMSI-Part1
The rightmost 39 bits of 5G-S-TMSI.
randomValue
Integer value in the range 0 to 2³⁹ − 1.
[. . .]

### 6.3.2 Radio Resource Control Information Elements

[ . . . ]

RadioBearerConfig

The IE RadioBearerConfig is used to add, modify and release signalling, multicast MRBs and/or data radio bearers. Specifically, this IE carries the parameters for PDCP and, if applicable, SDAP entities for the radio bearers.

### RadioBearerConfig Information Element

-- ASN1START
-- TAG-RADIOBEARERCONFIG-START

| | |
|---|---|
| RadioBearerConfig ::= | SEQUENCE { |
| srb-ToAddModList | SRB-ToAddModList |

OPTIONAL, -- Cond HO-Conn

| | |
|---|---|
| srb3-ToRelease | ENUMERATED{true} |

OPTIONAL, -- Need N

| | |
|---|---|
| drb-ToAddModList | DRB-ToAddModList |

OPTIONAL, -- Cond HO-toNR

| | |
|---|---|
| drb-ToReleaseList | DRB-ToReleaseList |

OPTIONAL, -- Need N

| | |
|---|---|
| securityConfig | SecurityConfig |

```
OPTIONAL, -- Need M
  ...,
  [[
```

| | |
|---|---|
| mrb-ToAddModList-r17 | MRB-ToAddModList-r17 |

OPTIONAL, -- Need N

| | |
|---|---|
| mrb-ToReleaseList-r17 | MRB-ToReleaseList-r17 |

OPTIONAL, -- Need N

| | |
|---|---|
| srb4-ToAddMod-r17 | SRB-ToAddMod |

OPTIONAL, -- Need N

| | |
|---|---|
| srb4-ToRelease-r17 | ENUMERATED{true} |

OPTIONAL -- Need N
]]
}

| | |
|---|---|
| SRB-ToAddModList ::= | SEQUENCE (SIZE (1..2)) OF SRB-ToAddMod |
| SRB-ToAddMod ::= | SEQUENCE { |
| srb-Identity | SRB-Identity, |
| reestablishPDCP | ENUMERATED{true} |

OPTIONAL, -- Need N

| | |
|---|---|
| discardOnPDCP | ENUMERATED{true} |

OPTIONAL, Need N

| | |
|---|---|
| pdcp-Config | PDCP-Config |

```
OPTIONAL, -- Cond PDCP
  ...,
  [[
```

| | |
|---|---|
| srb-Identity-v1700 | SRB-Identity-v1700 |

OPTIONAL -- Need M
]]
}

| | |
|---|---|
| DRB-ToAddModList ::= | SEQUENCE (SIZE (1..maxDRB)) OF DRB-ToAddMod |
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| | |
|---|---|
| drb-Identity | DRB-Identity, |
| reestablishPDCP | ENUMERATED{true} |

OPTIONAL, -- Need N

| | |
|---|---|
| recoverPDCP | ENUMERATED{true} |

OPTIONAL, -- Need N

| | |
|---|---|
| pdcp-Config | PDCP-Config |

```
OPTIONAL, -- Cond PDCP
  ...,
  [[
```

| | |
|---|---|
| daps-Config-r16 | ENUMERATED{true} |

OPTIONAL -- Cond DAPS
]]
}

| | |
|---|---|
| DRB-ToReleaseList ::= | SEQUENCE (SIZE (1..maxDRB)) OF DRB-Identity |
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, secondary} |

OPTIONAL, -- Cond RBTermChange
...
}

| | |
|---|---|
| MRB-ToAddModList-r17 ::= | SEQUENCE (SIZE (1..maxMRB-r17)) OF MRB-ToAddMod-r17 |
| MRB-ToAddMod-r17 ::= | SEQUENCE { |
| mbs-SessionId-r17 | TMGI-r17 |

OPTIONAL, -- Cond MRBSetup

| | |
|---|---|
| mrb-Identity-r17 | MRB-Identity-r17, |
| mrb-IdentityNew-r17 | MRB-Identity-r17 |

OPTIONAL, -- Need N

| | |
|---|---|
| reestablishPDCP-r17 | ENUMERATED{true} |

OPTIONAL, -- Need N

| | |
|---|---|
| recoverPDCP-r17 | ENUMERATED{true} |

OPTIONAL, -- Need N

| | |
|---|---|
| pdcp-Config-r17 | PDCP-Config |

OPTIONAL, -- Cond PDCP
...
}

| | |
|---|---|
| MRB-ToReleaseList-r17 ::= | SEQUENCE (SIZE (1..maxMRB-r17)) OF MRB-Identity-r17 |

-- TAG-RADIOBEARERCONFIG-STOP
-- ASN1STOP
[...]

RLC-BearerConfig

The IE RLC-BearerConfig is used to configure an RLC entity, a corresponding logical channel in MAC and the linking to a PDCP entity (served radio bearer).

### RLC-BearerConfig Information Element

-- ASN1START
-- TAG-RLC-BEARERCONFIG-START

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

}
OPTIONAL, -- Cond LCH-SetupOnly

| | |
|---|---|
| reestablishRLC | ENUMERATED {true} |

OPTIONAL, -- Need N

| | |
|---|---|
| rlc-Config | RLC-Config |

OPTIONAL, -- Cond LCH-Setup

| | |
|---|---|
| mac-LogicalChannelConfig | LogicalChannelConfig |

```
OPTIONAL, -- Cond LCH-Setup
  ...,
  [[
```

| | |
|---|---|
| rlc-Config-v1610 | RLC-Config-v1610 |

```
OPTIONAL -- Need R
  ]],
  [[
```

| | |
|---|---|
| rlc-Config-v1700 | RLC-Config-v1700 |

OPTIONAL, -- Need R

| | |
|---|---|
| logicalChannelIdentityExt-r17 | LogicalChannelIdentityExt-r17 |

OPTIONAL, -- Cond LCH-SetupModMRB

| | |
|---|---|
| multicastRLC-BearerConfig-r17 | MulticastRLC-BearerConfig-r17 |

OPTIONAL, -- Cond LCH-SetupOnlyMRB

| | |
|---|---|
| servedRadioBearerSRB4-r17 | SRB-Identity-v1700 |

OPTIONAL -- Need N
]]
}

| | |
|---|---|
| MulticastRLC-BearerConfig-r17 ::= | SEQUENCE { |
| servedMBS-RadioBearer-r17 | MRB-Identity-r17, |
| isPTM-Entity-r17 | ENUMERATED {true} |

OPTIONAL -- NEED S
}

| | |
|---|---|
| LogicalChannelIdentityExt-r17 ::= | INTEGER (320..65855) |

-- TAG-RLC-BEARERCONFIG-STOP
-- ASN1STOP

3GPP TS 38.321 specifies a random access procedure as follows:

### 5.1 Random Access Procedure

Editor's NOTE: Msg.1 based early identification captured in 5.1.1 and 5.1.1a part will be handled together with other features (e.g. coverage, slicing, SDT, etc.) in common MAC running CR for RACH indication and partitioning.

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-PreambleIndex different from 0b000000.
NOTE 1: If a new Random Access procedure is triggered while another is already ongoing in the MAC entity, it is up to UE implementation whether to continue with the ongoing procedure or start with the new procedure (e.g. for SI request).
NOTE 2: If there was an ongoing Random Access procedure that is triggered by a PDCCH order while the UE receives another PDCCH order indicating the same Random Access Preamble, PRACH mask index and uplink carrier, the Random Access procedure is considered as the same Random Access procedure as the ongoing one and not initialized again.
   When a Random Access procedure is initiated, UE selects a set of Random Access resources as specified in clause 5.1.1b and initialises the following parameters for the Random Access procedure according to the values configured by RRC for the selected set of Random Access resources:
   [ . . . ]
   5.1.2 Random Access Resource selection
   [ . . . ]
   5.1.3 Random Access Preamble transmission
   [ . . . ]
   5.1.4 Random Access Response reception
   Once the Random Access Preamble is transmitted and regardless of the possible occurrence of a measurement gap, the MAC entity shall:
1> if the contention-free Random Access Preamble for beam failure recovery request was transmitted by the MAC entity:
   2> if the contention-free Random Access Preamble for beam failure recovery request was transmitted on a non-terrestrial network:
      3> start the ra-Response Window configured in BeamFailureRecoveryConfig at the PDCCH occasion as specified in TS 38.213 [6].
   2> else:
      3> start the ra-Response Window configured in BeamFailureRecoveryConfig at the first PDCCH occasion as specified in TS 38.213 [6] from the end of the Random Access Preamble transmission.
   2> monitor for a PDCCH transmission on the search space indicated by recoverySearchSpaceId of the SpCell identified by the C-RNTI while ra-ResponseWindow is running.
1> else:
   2> if the Random Access Preamble was transmitted on a non-terrestrial network:
      3> start the ra-Response Window configured in RACH-ConfigCommon at the PDCCH occasion as specified in TS 38.213 [6].
   2> else:
      3> start the ra-Response Window configured in RACH-ConfigCommon at the first PDCCH occasion as specified in TS 38.213 [6] from the end of the Random Access Preamble transmission.
   2> monitor the PDCCH of the SpCell for Random Access Response(s) identified by the RA-RNTI while the ra-Response Window is running.
1> if notification of a reception of a PDCCH transmission on the search space indicated by recoverySearchSpaceId is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> apply the following actions for the Serving Cell where the Random Access Preamble was transmitted:
         5> process the received Timing Advance Command (see clause 5.2);
         5> indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5> if the Random Access procedure for an SCell is performed on uplink carrier where pusch-Config is not configured:
         6> ignore the received UL grant.
         5> else:
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> if the Random Access procedure was initiated for SpCell beam failure recovery and spCell-BFR-CBRA with value true is configured:
         7> if there is at least one Serving Cell of this MAC entity configured with two BFD-RS sets:
         8> indicate to the Multiplexing and assembly entity to include an Enhanced BFR MAC CE or a Truncated Enhanced BFR MAC CE in the subsequent uplink transmission.
         7> else:
         8> indicate to the Multiplexing and assembly entity to include a BFR MAC CE or a Truncated BFR MAC CE in the subsequent uplink transmission.
         6> else if the Random Access procedure was initiated for beam failure recovery of both BFD-RS sets of SpCell:
         7> indicate to the Multiplexing and assembly entity to include an Enhanced BFR MAC CE or a Truncated Enhanced BFR MAC CE in the subsequent uplink transmission.
         6> obtain the MAC PDU to transmit from the Multiplexing and assembly entity and store it in the Msg3 buffer.
NOTE: If within a Random Access procedure, an uplink grant provided in the Random Access Response for the same group of contention-based Random Access Preambles has a different size than the first uplink grant allocated during that Random Access procedure, the UE behavior is not defined.
1> if ra-Response Window configured in BeamFailureRecoveryConfig expires and if a PDCCH transmission on the search space indicated by recoverySearchSpaceId addressed to the C-RNTI has not been received on the Serving Cell where the preamble was transmitted; or
1> if ra-Response Window configured in RACH-ConfigCommon expires, and if the Random Access Response containing Random Access Preamble identifiers that matches the transmitted PREAMBLE INDEX has not been received:
   2> consider the Random Access Response reception not successful;
   2> increment PREAMBLE_TRANSMISSION_COUNTER by 1;
   2> if PREAMBLE_TRANSMISSION_COUNTER=preambleTransMax+1:
      3> if the Random Access Preamble is transmitted on the SpCell:
         4> indicate a Random Access problem to upper layers;
         4> if this Random Access procedure was triggered for SI request:
         5> consider the Random Access procedure unsuccessfully completed.
      3> else if the Random Access Preamble is transmitted on an SCell:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in clause 5.1.2) to select contention-free Random Access Resources is met during the backoff time:
         4> perform the Random Access Resource selection procedure (see clause 5.1.2);
      3> else if the Random Access procedure for an SCell is performed on uplink carrier where pusch-Config is not configured:
         4> delay the subsequent Random Access transmission until the Random Access Procedure is triggered by a PDCCH order with the same ra-PreambleIndex, ra-ssb-OccosionMaskIndex, and UL/SUL indicator TS 38.212 [9].
      3> else:
         4> perform the Random Access Resource selection procedure (see clause 5.1.2) after the backoff time.
            The MAC entity may stop ra-Response Window (and hence monitoring for Random Access Response(s)) after successful reception of a Random Access Response containing Random Access Preamble identifiers that matches the transmitted PREAMBLE INDEX.
            HARQ operation is not applicable to the Random Access Response reception.
            [ . . . ]

### 5.1.5 Contention Resolution

Once Msg3 is transmitted the MAC entity shall:
1> if Msg3 is transmitted on a non-terrestrial network:
   2> start the ra-ContentionResolutionTimer and restart the ra-ContentionResolutionTimer at each HARQ retransmission in the first symbol after the end of the Msg3 transmission plus the UE estimate of UE-gNB RTT.
1> else if the Msg3 transmission (i.e. initial transmission or HARQ retransmission) is scheduled with Type A PUSCH repetition:
   2> start or restart the ra-ContentionResolutionTimer in the first symbol after the end of all repetitions of the Msg3 transmission.
1> else:
   2> start or restart the ra-ContentionResolutionTimer in the first symbol after the end of the Msg3 transmission.
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery or for beam failure recovery of both BFD-RS sets of SpCell (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.
1> if ra-ContentionResolutionTimer expires:
   2> if Msg3 is transmitted on a non-terrestrial network and ra-ContentionResolutionTimer expires prior to the first symbol after the end of a Msg3 retransmission plus the UE estimate of UE-gNB RTT:
      3> do not consider the Contention Resolution unsuccessful.
   2> else:
      3> discard the TEMPORARY_C-RNTI;
      3> consider the Contention Resolution not successful.
1> if the Contention Resolution is considered not successful:
   2> flush the HARQ buffer used for transmission of the MAC PDU in the Msg3 buffer;
   2> increment PREAMBLE_TRANSMISSION_COUNTER by 1;
   2> if PREAMBLE_TRANSMISSION_COUNTER=preambleTransMax+1:
      3> indicate a Random Access problem to upper layers.
      3> if this Random Access procedure was triggered for SI request:
         4> consider the Random Access procedure unsuccessfully completed.
   2> if the Random Access procedure is not completed:
      3> if the RA TYPE is set to 4-stepRA:
         4> select a random backoff time according to a uniform distribution between 0 and the PREAMBLE_BACKOFF;
         4> if the criteria (as defined in clause 5.1.2) to select contention-free Random Access Resources is met during the backoff time:
         5> perform the Random Access Resource selection procedure (see clause 5.1.2);
         4> else:
         5> perform the Random Access Resource selection procedure (see clause 5.1.2) after the backoff time.
      3> else (i.e. the RA TYPE is set to 2-stepRA):
         4> if msgA-TransMax is applied (see clause 5.1.1a) and PREAMBLE_TRANSMISSION_COUNTER=msgA-TransMax+1:
         5> set the RA TYPE to 4-stepRA;
         5> perform initialization of variables specific to Random Access type as specified in clause 5.1.1a;
         5> flush HARQ buffer used for the transmission of MAC PDU in the MSGA buffer;
         5> discard explicitly signalled contention-free 2-step RA type Random Access Resources, if any;
         5> perform the Random Access Resource selection as specified in clause 5.1.2.
         4> else:
         5> select a random backoff time according to a uniform distribution between 0 and the PREAMBLE_BACKOFF;
         5> if the criteria (as defined in clause 5.1.2a) to select contention-free Random Access Resources is met during the backoff time:
         6> perform the Random Access Resource selection procedure for 2-step RA type as specified in clause 5.1.2a.
         5> else:
         6> perform the Random Access Resource selection for 2-step RA type procedure (see clause 5.1.2a) after the backoff time.
            5.1.6 Completion of the Random Access procedure
            Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.
   Upon successful completion of the Random Access procedure initiated for DAPS handover, the target MAC entity shall:
1> indicate the successful completion of the Random Access procedure to the upper layers.

3GPP TS 38.323 specifies transmit operation in Packet Data Convergence Protocol (PDCP) as follows:

### 5.2 Data Transfer

### 5.2.1 Transmit Operation

At reception of a PDCP SDU from upper layers, the transmitting PDCP entity shall:
start the discard Timer associated with this PDCP SDU (if configured).
   For a PDCP SDU received from upper layers, the transmitting PDCP entity shall:
associate the COUNT value corresponding to TX_NEXT to this PDCP SDU;
NOTE 1: Associating more than half of the PDCP SN space of contiguous PDCP SDUs with PDCP SNs, when e.g., the PDCP SDUs are discarded or transmitted without acknowledgement, may cause HFN desynchronization problem. How to prevent HFN desynchronization problem is left up to UE implementation.
perform header compression of the PDCP SDU using ROHC as specified in the clause 5.7.4 and/or using EHC as specified in the clause 5.12.4;
perform uplink data compression of the PDCP SDU as specified in clause 5.14.4;
perform integrity protection, and ciphering using the TX_NEXT as specified in the clause 5.9 and 5.8, respectively;
set the PDCP SN of the PDCP Data PDU to TX_NEXT modulo 2^{[pdcp-SN-SizeUL]};
increment TX_NEXT by one;
submit the resulting PDCP Data PDU to lower layer as specified below.
   When submitting a PDCP PDU to lower layer, the transmitting PDCP entity shall:
if the transmitting PDCP entity is associated with one RLC entity:
   submit the PDCP PDU to the associated RLC entity;
else, if the transmitting PDCP entity is associated with at least two RLC entities:
   if the PDCP duplication is activated for the RB:
      if the PDCP PDU is a PDCP Data PDU:
         duplicate the PDCP Data PDU and submit the PDCP Data PDU to the associated RLC entities activated for PDCP duplication;
      else:
         submit the PDCP Control PDU to the primary RLC entity;
else (i.e. the PDCP duplication is deactivated for the RB or the RB is a DAPS bearer):
   if the split secondary RLC entity is configured; and
   if the total amount of PDCP data volume and RLC data volume pending for initial transmission (as specified in TS 38.322 [5]) in the primary RLC entity and the split secondary RLC entity is equal to or larger than ul-DataSplitThreshold:
      submit the PDCP PDU to either the primary RLC entity or the split secondary RLC entity;
   else, if the transmitting PDCP entity is associated with the DAPS bearer:
      if the uplink data switching has not been requested:
         submit the PDCP PDU to the RLC entity associated with the source cell;
      else:
         if the PDCP PDU is a PDCP Data PDU:
         submit the PDCP Data PDU to the RLC entity associated with the target cell;
         else:
         if the PDCP Control PDU is associated with source cell:
         submit the PDCP Control PDU to the RLC entity associated with the source cell;
         else:
         submit the PDCP Control PDU to the RLC entity associated with the target cell;
   else:
      submit the PDCP PDU to the primary RLC entity.
NOTE 2: If the transmitting PDCP entity is associated with two RLC entities, the UE should minimize the amount of PDCP PDUs submitted to lower layers before receiving request from lower layers and minimize the PDCP SN gap between PDCP PDUs submitted to two associated RLC entities to minimize PDCP reordering delay in the receiving PDCP entity.
   [ . . . ]

As described in 3GPP RP-213585, there may be two different scenarios of multi-path communication i.e. a UE is connected to the same gNB using one direct path and one indirect path via 1) a Layer-2 UE-to-Network relay, or 2) via another UE using a non-3GPP standardized UE-UE inter-connection. In the second scenario, the UE may be named as Anchor UE and another UE may be named as Aggregated UE. Besides, an Anchor UE may communicate with a data network via one or multiple Aggregated UEs to improve reliability or throughput. And, the relationship between anchor UE and aggregated UE may be relative static and could be pre-configured (as discussed in 3GPP R2-2208429), which implies that the Aggregated UE(s) could be known to the Anchor UE beforehand. How to establish multi-path communication with the data network via Aggregated UE(s) should be considered.

In case the Quality of Service (QoS) requirement of a concerned application or service is high so that multi-path communication is required or preferred to support the concerned application or service, the Anchor UE may request gNB to add the indirect link associated with an Aggregated UE. After the indirect link is added, the Anchor UE may then establish a Protocol Data Unit (PDU) session with the data network for accessing the concerned application or service. The gNB may configure at least a Data Radio Bearer (DRB) to the Anchor UE for the PDU session via a RRC Reconfiguration message.

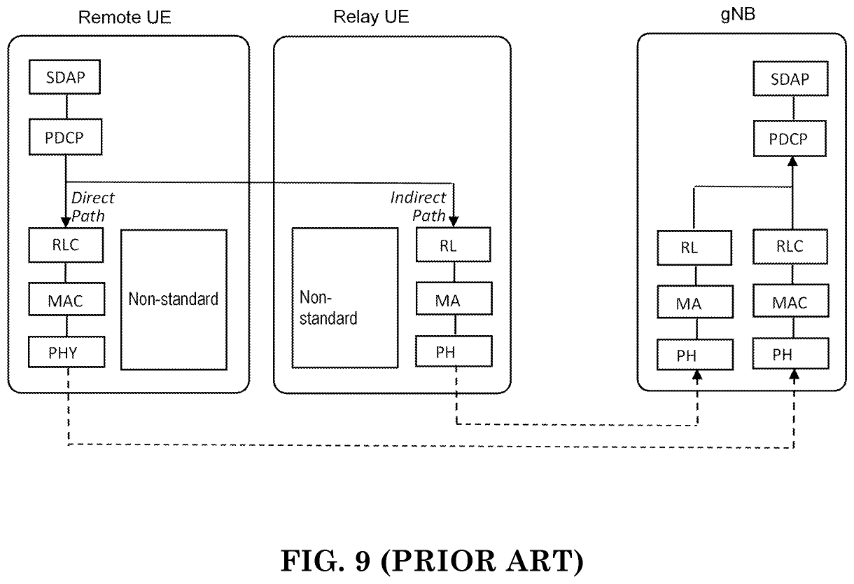

A DRB configured to the Anchor UE may be mapped to at least a Radio Link Control (RLC) entity (or a logical channel) over the direct path and a RLC entity (or a logical channel) over the indirect path. The RLC entity over the direct path is established by the Anchor UE and the RLC entity over the indirect path is established by the Aggregated UE as shown in FIG. 9, which shows a User Plane (UP) protocol stack for multi-path communication with relay UE. The Anchor UE may transmit a data packet of the DRB on either the RLC entity (or the logical channel) over the direct path or the RLC entity (or the logical channel) over the indirect path if the DRB is a split bearer. In case the DRB is configured with PDCP duplication, the Anchor UE may transmit the data packet of the DRB on both the RLC entity (or the logical channel) over the direct path and the RLC entity (or the logical channel) over the indirect path. The RRC Reconfiguration message may include information to indicate whether PDCP duplication is configured to the DRB (e.g. with IE pdcp-Duplication) or whether the DRB is a split bearer (e.g. with IE splitSecondaryPath).

In FIG. 9, a data packet from the PDCP of the Anchor UE seems to go to the RLC entity of the Aggregated UE directly. In implementation, the data packet would first go to the Non-standard part of the Anchor UE and then be sent to the Non-standard part of the Aggregated UE. Afterward, the Non-standard part of the Aggregated UE would deliver the data packet to the RLC entity of the Aggregated UE. Finally, the data packet would be transmitted to the gNB via the Uu interface.

Basically, the gNB should provide the RLC configuration of the RLC entity over the direct path to the Anchor UE. In addition, the gNB may provide the RLC configuration of the RLC entity over the indirect path to the Aggregated UE directly. Alternatively, the gNB may provide the RLC configuration of the RLC entity over the indirect path to the Anchor UE and then the Anchor UE forwards the RLC configuration to the Aggregated UE. In case multiple Aggregated UEs are added, each RLC configuration of the RLC entity (or logical channel) over the indirect path should be associated with an Aggregated UE (i.e. an ID of the Aggregated UE, e.g. C-RNTI, should be included in the RRC Reconfiguration message sent from the gNB to the Anchor UE).

It is also possible that the Anchor UE may establish the PDU session with the data network for accessing the concerned application or service before the indirect link is added. In this situation, the gNB could reconfigure a DRB which was configured before the indirect link is added to map the DRB to at least an RLC entity (or a logical channel) over the direct path and an RLC entity (or a logical channel) over the indirect path.

To let the gNB know the association between the Anchor UE and the Aggregated UE, one potential way is for the Anchor UE to indicate the Aggregated UE to the gNB, e.g. by including an initial UE identity or a Cell Radio Network Temporary Identifier (C-RNTI) of the Aggregated UE in a RRC message sent to the gNB. Alternatively, the Aggregated UE may indicate the Anchor UE to the gNB, e.g. by including an initial UE identity or a C-RNTI of the Anchor UE in a RRC message sent to the gNB. The RRC message may be a RRC Setup Request message used by the Aggregated UE to establish a RRC connection with the gNB. The C-RNTI of a UE may be provided to the UE by the gNB via a RRC Reconfiguration message (as discussed in 3GPP TS 38.331) or a Random Access Response (as discussed in 3GPP TS 38.321). And, the initial UE identity of a UE may be an ng-5G-S-TMSI-Partl or a random value included by the UE in a RRC Setup Request message (as discussed in 3GPP TS 38.331).

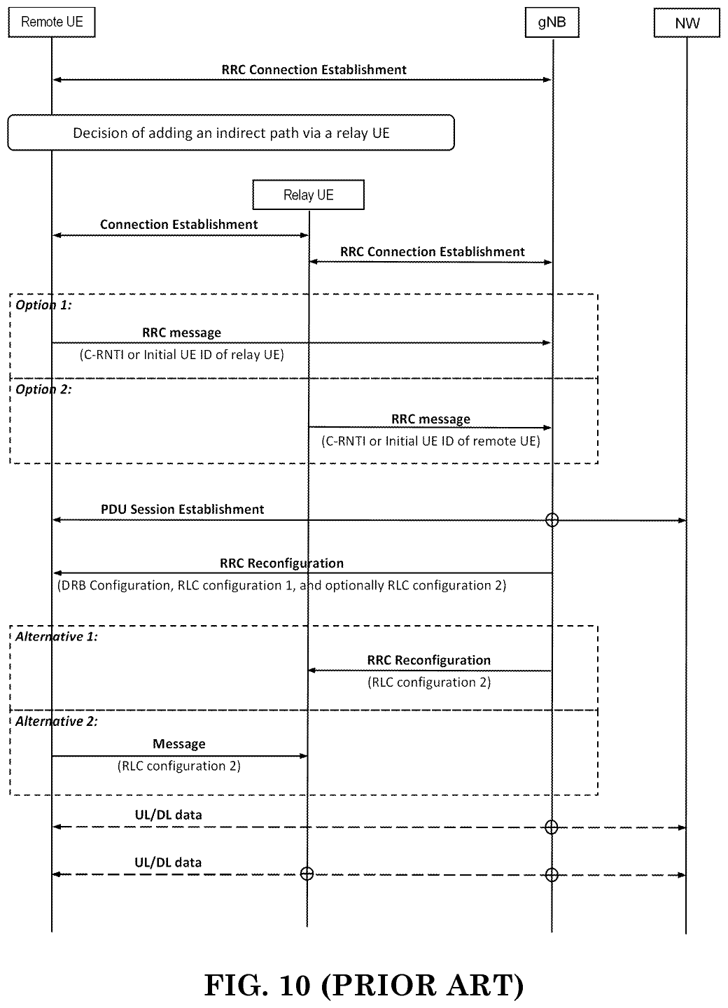

FIG. 10 illustrates examples of the above solutions to add an indirect path for supporting multi-path communication according to one exemplary embodiment.

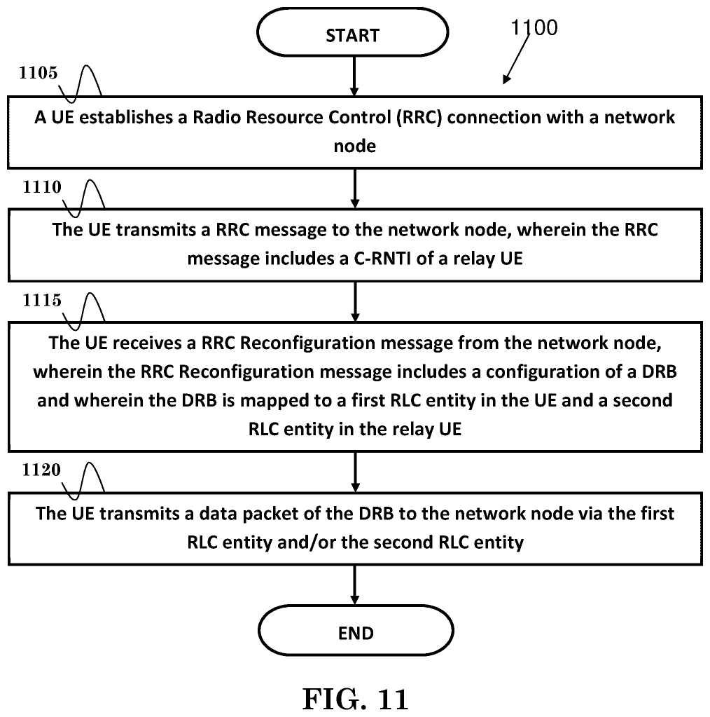

FIG. 11 is a flow chart 1100 of a method for supporting multi-path transmission or communication. In step 1105, a UE establishes a RRC connection with a network node. In step 1110, the UE transmits a RRC message to the network node, wherein the RRC message includes a C-RNTI of a relay UE. In step 1115, the UE receives a RRC Reconfiguration message from the network node, wherein the RRC Reconfiguration message includes a configuration of a DRB and wherein the DRB is mapped to a first RLC entity in the UE and a second RLC entity in the relay UE. In step 1120, the UE transmits a data packet of the DRB to the network node via the first RLC entity and/or the second RLC entity.

In one embodiment, the RRC Reconfiguration message may include an identity of a PDU session and wherein the DRB is associated with the PDU session. The DRB could be a split bearer with or without PDCP duplication. The data packet is transmitted via the first RLC entity and the second RLC entity if the DRB is configured with PDCP duplication. The data packet is transmitted via one of the first RLC entity and the second RLC entity if the DRB is not configured with PDCP duplication. The first RLC entity could be used for transmission over a direct path between the UE and the network node and the second RLC entity is used for transmission over an indirect path between the relay UE and the network node. The UE could communicate with the relay UE via a non-3GPP standardized inter-connection.

Referring back to FIGS. 3 and 4, in one exemplary embodiment of a method for a UE, the UE 300 includes a program code 312 stored in the memory 310. The CPU 308 could execute program code 312 to enable the UE (i) to establish a RRC connection with a network node, (ii) to transmit a RRC message to the network node, wherein the RRC message includes a C-RNTI of a relay UE, (iii) to receive a RRC Reconfiguration message from the network node, wherein the RRC Reconfiguration message includes a configuration of a DRB and wherein the DRB is mapped to a first RLC entity in the UE and a second RLC entity in the relay UE, and (iv) to transmit a data packet of the DRB to the network node via the first RLC entity and/or the second RLC entity. Furthermore, the CPU 308 can execute the program code 312 to perform all of the above-described actions and steps or others described herein.

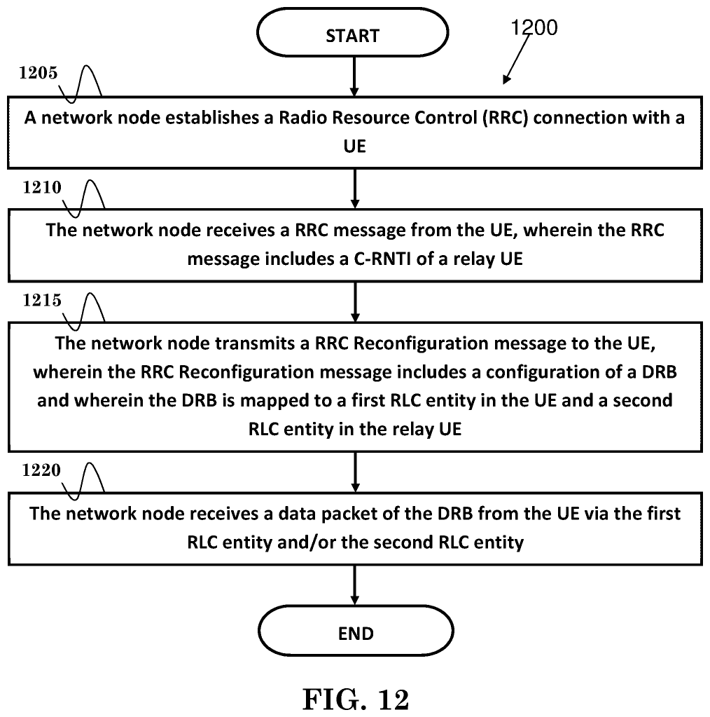

FIG. 12 is a flow chart 1200 of a method for supporting multi-path transmission or communication. In step 1205, a network node establishes a RRC connection with a UE. In step 1210, the network node receives a RRC message from the UE, wherein the RRC message includes a C-RNTI of a relay UE. In step 1215, the network node transmits a RRC Reconfiguration message to the UE, wherein the RRC Reconfiguration message includes a configuration of a DRB and wherein the DRB is mapped to a first RLC entity in the UE and a second RLC entity in the relay UE. In step 1210, the network node receives a data packet of the DRB from the UE via the first RLC entity and/or the second RLC entity.

In one embodiment, the RRC Reconfiguration message may include an identity of a PDU session and wherein the DRB is associated with the PDU session. The DRB may be a split bearer with or without PDCP duplication. The first RLC entity could be used for transmission over a direct path between the UE and the network node and the second RLC entity is used for transmission over an indirect path between the relay UE and the network node.

Referring back to FIGS. 3 and 4, in one exemplary embodiment of a method for a network node, the network node 300 includes a program code 312 stored in the memory 310. The CPU 308 could execute program code 312 to enable the network node (i) to establish a RRC connection with a UE, (ii) to receive a RRC message from the UE, wherein the RRC message includes a C-RNTI of a relay UE, (iii) to transmit a RRC Reconfiguration message to the UE, wherein the RRC Reconfiguration message includes a configuration of a DRB and wherein the DRB is mapped to a first RLC entity in the UE and a second RLC entity in the relay UE, and (iv) to receive a data packet of the DRB from the UE via the first RLC entity and/or the second RLC entity. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for supporting multi-path transmission or communication, comprising:
a User Equipment (UE) establishes a Radio Resource Control (RRC) connection with a network node;
the UE transmits a RRC message to the network node, wherein the RRC message includes a Cell Radio Network Temporary Identifier (C-RNTI) of a relay UE;
the UE receives a RRC Reconfiguration message from the network node, wherein the RRC Reconfiguration message includes a configuration of a Data Radio Bearer (DRB) and wherein the DRB is mapped to a first Radio Link Control (RLC) entity in the UE and a second RLC entity in the relay UE; and
the UE transmits a data packet of the DRB to the network node via the first RLC entity and/or the second RLC entity.

2. The method of claim 1, wherein the RRC Reconfiguration message includes an identity of a Protocol Data Unit (PDU) session and wherein the DRB is associated with the PDU session.

3. The method of claim 1, wherein the DRB is a split bearer with or without Packet Data Convergence Protocol (PDCP) duplication.

4. The method of claim 3, wherein the data packet is transmitted via the first RLC entity and the second RLC entity if the DRB is configured with PDCP duplication.

5. The method of claim 3, wherein the data packet is transmitted via one of the first RLC entity and the second RLC entity if the DRB is not configured with PDCP duplication.

6. The method of claim 1, wherein the first RLC entity is used for transmission over a direct path between the UE and the network node and the second RLC entity is used for transmission over an indirect path between the relay UE and the network node.

7. The method of claim 1, wherein the UE communicates with the relay UE via a non-3GPP standardized inter-connection.

8. A UE (User Equipment), comprising:
a control circuit;
a processor installed in the control circuit; and
a memory installed in the control circuit and operatively coupled to the processor;
wherein the processor is configured to execute a program code stored in the memory to:
establish a Radio Resource Control (RRC) connection with a network node;
transmit a RRC message to the network node, wherein the RRC message includes a Cell Radio Network Temporary Identifier (C-RNTI) of a relay UE;
receive a RRC Reconfiguration message from the network node, wherein the RRC Reconfiguration message includes a configuration of a Data Radio Bearer (DRB) and wherein the DRB is mapped to a first Radio Link Control (RLC) entity in the UE and a second RLC entity in the relay UE; and
transmit a data packet of the DRB to the network node via the first RLC entity and/or the second RLC entity.

9. The UE of claim 8, wherein the RRC Reconfiguration message includes an identity of a Protocol Data Unit (PDU) session and wherein the DRB is associated with the PDU session.

10. The UE of claim 8, wherein the DRB is a split bearer with or without Packet Data Convergence Protocol (PDCP) duplication.

11. The UE of claim 10, wherein the data packet is transmitted via the first RLC entity and the second RLC entity if the DRB is configured with PDCP duplication.

12. The UE of claim 10, wherein the data packet is transmitted via one of the first RLC entity and the second RLC entity if the DRB is not configured with PDCP duplication.

13. The UE of claim 8, wherein the first RLC entity is used for transmission over a direct path between the UE and the network node and the second RLC entity is used for transmission over an indirect path between the relay UE and the network node.

14. The UE of claim 8, wherein the UE communicates with the relay UE via a non-3GPP standardized inter-connection.

15. A method for supporting multi-path transmission or communication, comprising:
a network node establishes a Radio Resource Control (RRC) connection with a User Equipment (UE);
the network node receives a Radio Resource Control (RRC) message from the UE, wherein the RRC message includes a Cell Radio Network Temporary Identifier (C-RNTI) of a relay UE;
the network node transmits a RRC Reconfiguration message to the UE, wherein the RRC Reconfiguration message includes a configuration of a Data Radio Bearer (DRB) and wherein the DRB is mapped to a first Radio Link Control (RLC) entity in the UE and a second RLC entity in the relay UE; and
the network node receives a data packet of the DRB from the UE via the first RLC entity and/or the second RLC entity.

16. The method of claim 15, wherein the RRC Reconfiguration message includes an identity of a PDU session and wherein the DRB is associated with the Protocol Data Unit (PDU) session.

17. The method of claim 15, wherein the DRB is a split bearer with or without Packet Data Convergence Protocol (PDCP) duplication.

18. The method of claim 15, wherein the first RLC entity is used for transmission over a direct path between the UE and the network node and the second RLC entity is used for transmission over an indirect path between the relay UE and the network node.
